(19) United States
(12) Patent Application Publication
(10) Pub. No.: US 2007/0212164 A1
(43) Pub. Date: Sep. 13, 2007

(54) Ball Socket

(76) Inventors: Otto Bosse, Hamburg (DE); Markus Guetzlaff, Sindelfingen (DE); Manfred Juergens, Hamburg (DE); Wolfgang Sievers, Hamburg (DE); Thomas Ulbrich, Glinde (DE); Mareike Wendt, Alveslohe (DE)

Correspondence Address: KENYON & KENYON LLP, ONE BROADWAY, NEW YORK, NY, 10004, US

(21) Appl. No.: 10/574,741

(22) PCT Filed: Oct. 1, 2004
(86) PCT No.: PCT/EP04/10957

§ 371 Date: Jan. 16, 2007

(30) Foreign Application Priority Data
Oct. 4, 2003 (DE) 103 46 068.3

(51) Int. Cl. F16C 11/06

(52) U.S. Cl. 403/132

(57) ABSTRACT

A ball socket for receiving a ball has at least one region which includes an elastically deformable material or has an elastically deformable geometry. The ball socket may not break when it is bent open for introduction of the ball and then springs back into its original position. This may provide simple assembly of a ball joint including a ball socket and a ball. Moreover, the ball may be securely received in the ball socket.

### FIELD OF THE INVENTION

The present invention relates to a ball socket for receiving a ball and to a rotatably mounted connecting arrangement for connecting two components in a vehicle.

### BACKGROUND INFORMATION

Rotatably mounted connecting arrangements for connecting vehicle components or ball joints can perform various functions in motor vehicles. One component that is to be connected has a ball at one end, while the other component that is to be connected has a ball socket or ball cage at one end. To provide the connection between the two components, the ball is received in the ball socket or ball cage. This arrangement allows the two components to pivot relative to one another about a common pivot point which is arranged in the ball joint.

Conventional single-piece ball sockets made from soft material do not have the rigidity required for certain applications. Single-piece ball sockets made from hard and brittle plastic do have the required rigidity but are subject to the drawback that they can break when they are bent open during fitting to the ball. Consequently, the strip thickness and the wrapping of the ball socket around the ball are subject to restrictions. Forced deformation being possible during insertion of the ball into the ball socket is detrimental to the shape of the ball sockets.

German Published Patent Application No. 42 11 897 describes a ball joint for parts of a steering mechanism or wheel suspension of motor vehicles. This ball joint has a radially resilient bearing socket which is made from plastic and accommodates a ball head of a link pin. The outer circumference of the bearing socket is mounted in a recess in a joint housing, and a cylindrical part of its peripheral surfaces bears against a cylindrical wall portion. The bearing socket surrounds the ball head by a securing member which is inserted into the housing recess and secures the bearing socket prestressed therein. The bearing socket has a slot passing through it transversely to the circumferential direction. Insertion of the ball into the bearing socket is facilitated by this design.

### SUMMARY

Example embodiments of the present invention provide for configuration of a ball socket and for configuration of a rotatably mounted connecting arrangement.

The ball socket for receiving a ball includes at least one region which includes an elastically deformable material or has an elastically deformable geometry. The result of this is that the ball socket may not break when it is bent open as a result of the ball being introduced and then returns to its original position. This may provide for simple assembly of a ball joint that includes a ball socket and a ball. Moreover, the ball may be securely received in the ball socket.

The ball socket may be arranged such that it covers a ball portion, which is delimited by at least one circle, of the ball. It is also possible for the ball socket to be arranged such that it covers a ball portion, which is delimited by two circles arranged parallel to one another and is arranged as a ball layer, of the ball. It may be provided that the ball socket engages around an equator of the ball. The ball portion may be arranged such that it surrounds the ball apart from an opening at one pole of the ball. The ball layer is formed such that it surrounds the ball apart from two openings at opposite poles of the ball. The ball socket, which is arranged as a ball layer, covers the ball in a region up to several degrees above the equator and also in a region up to several degrees below the equator of the ball.

It may be provided that the ball socket has at least one gap. For example, the at least one gap may be oriented perpendicular to the at least one circle, e.g., to the at least two circles, of the ball socket arranged as a ball layer. An opening of this type arranged at the ball socket may allow widening of the ball socket during fitting of the ball.

The elastically deformable region may be arranged as an elongate portion which is arranged diagonally with respect to the gap. This may make it easy for the ball socket to widen during assembly. Since the gap and the elastically deformable region are arranged diagonally with respect to one another, maximum opening of the ball socket may be possible in a direction perpendicular to the gap.

Alternatively, the ball socket may have two gaps which are arranged diagonally with respect to one another along a circumference of the ball. On account of this configuration of the ball socket, there are two options for an arrangement of the elastically deformable region.

The elastically deformable region may be arranged between a gap. If the ball socket is arranged in the form of a ball layer with two gaps arranged diagonally with respect to one another, this configuration in functional terms corresponds to the variant of forming the ball layer with a gap and an elastically deformable region arranged diagonally with respect to the gap as the elongate portion. However, if the ball socket is formed as a ball portion which is delimited by one circle, this ball portion may have a gap at which the elastically deformable region is arranged. Therefore, a single-piece ball socket having two components which may move relative to one another by the elastically deformable region is in each case provided.

If the ball socket has two gaps, it may be provided that the elastically deformable region is arranged between a first point and a second point of the circle which delimits the ball socket. This may provide a cohesive, single-piece ball socket which has two components which are connected such that they may move relative to one another by the elastically deformable region and form a ball socket.

The two components of the ball socket which are connected to one another by the elastically deformable region may be formed of hard and brittle plastic. The elastically deformable region may be of thin-walled design. This means that the elastically deformable region has a lower wall thickness than the two components. On account of this configuration, the ball socket may easily be deformed along the elastically deformable region such that the other two components forming the ball socket may move in a simple manner relative to one another and, moreover, securely hold the ball within the ball socket.

In the rotatably mounted connecting arrangement for connecting two parts in a vehicle, the first part has a ball as connecting element and the second part has the ball socket as a connecting element for receiving the ball. A connecting arrangement of this type or a ball joint of this type may be versatile in use in the motor vehicle. Assembly may be executed without problems on account of the configuration of the connecting arrangement.

Further aspects and configurations of example embodiments of the present invention are described below with reference to the appended Figures.

It should be understood that the features referred to above and those which are yet to be explained below may be used not only in the combination indicated in each instance but also in other combinations or also as stand-alone measures, without departing from the spirit and scope hereof.

### BRIEF DESCRIPTION OF THE DRAWINGS

FIG. 1 schematically illustrates a configuration of a ball socket according to an example embodiment of the present invention.

FIG. 2 is a cross-sectional view of the ball socket illustrated in FIG. 1.

FIGS. 3 to 5 schematically illustrate the insertion of a ball into the ball socket illustrated in FIGS. 1 and 2.

FIG. 6 schematically illustrate a ball socket according to an example embodiment of the present invention.

FIG. 7 is a cross-sectional view through the ball socket illustrated in FIG. 6.

FIGS. 8 and 9 schematically illustrate the insertion of a ball into a ball socket illustrated in FIGS. 6 and 7.

### DETAILED DESCRIPTION

The Figures are described jointly and in an interrelated manner. Identical reference designations denote identical components.

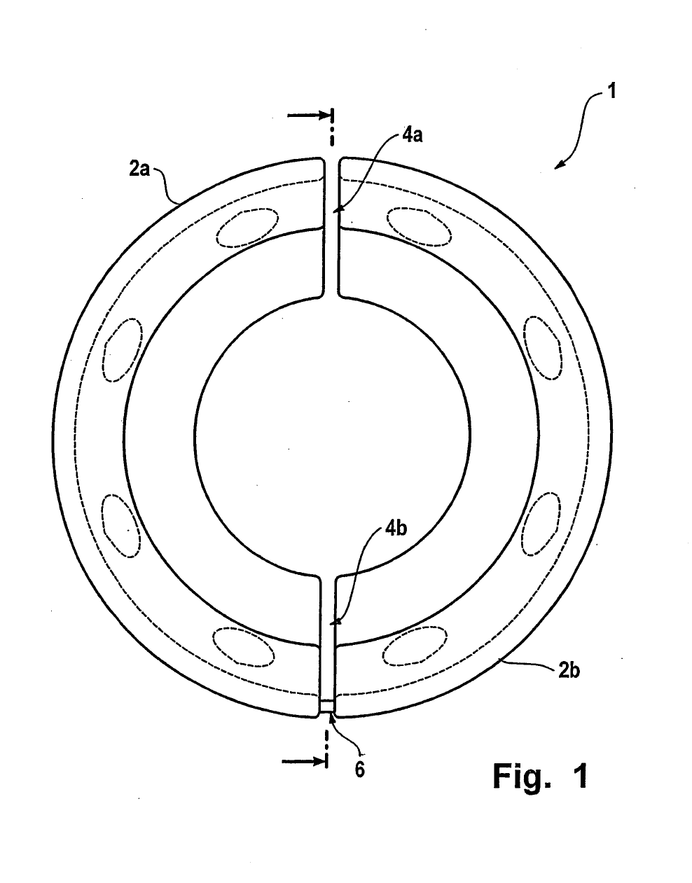

An example embodiment of a ball socket 1, which is illustrated from various perspectives and in different states in FIGS. 1 to 5, has the following components: two part-sockets 2a, 2b, which are connected to one another via an elastically deformable region 6 such that the entire ball socket 1 is of single-piece, cohesive arrangement. Moreover, the ball socket 1 has a first gap 4a and a second gap 4b. The first gap 4a separates the two part-sockets 2a, 2b from one another. Along the second gap 4b is arranged the elastically deformable region 6, by which the two part-sockets 2a, 2b are connected to one another so that they jointly and in single-piece form produce the ball socket 1.

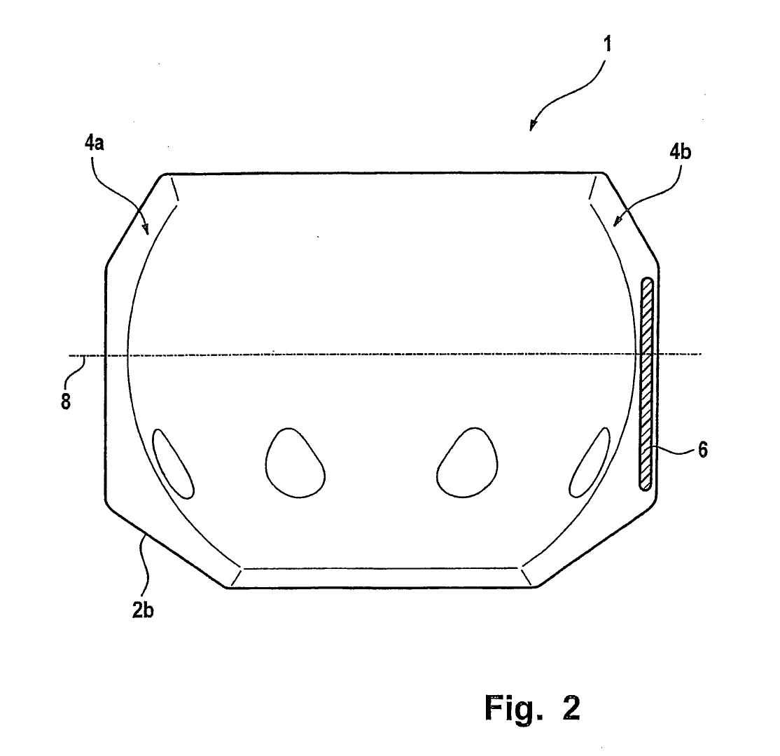

FIG. 2 illustrates the ball socket 1 illustrated in FIG. 1 in a cross-sectional view from a perspective corresponding to the two arrows indicated in FIG. 1. This perspective reveals the part-socket 2b. The section passes through the two gaps 4a (left-hand side) and 4b (right-hand side) arranged diagonally with respect to one another. The elastically deformable region 6 is arranged along the gap 4b illustrated on the right-hand side, diagonally with respect to the gap 4a illustrated on the left-hand side. FIG. 2 also indicates an equator line illustrating an equator 8 of the ball 10. The part-socket 2b, relative to the equator 8, extends from a first angle region above the equator 8 to a lower angle region below the equator 8. The same applies to the part-socket 2a. This provides that a ball which is to be received by the ball socket 1 is substantially covered or encircled so that the ball is securely held in the ball socket.

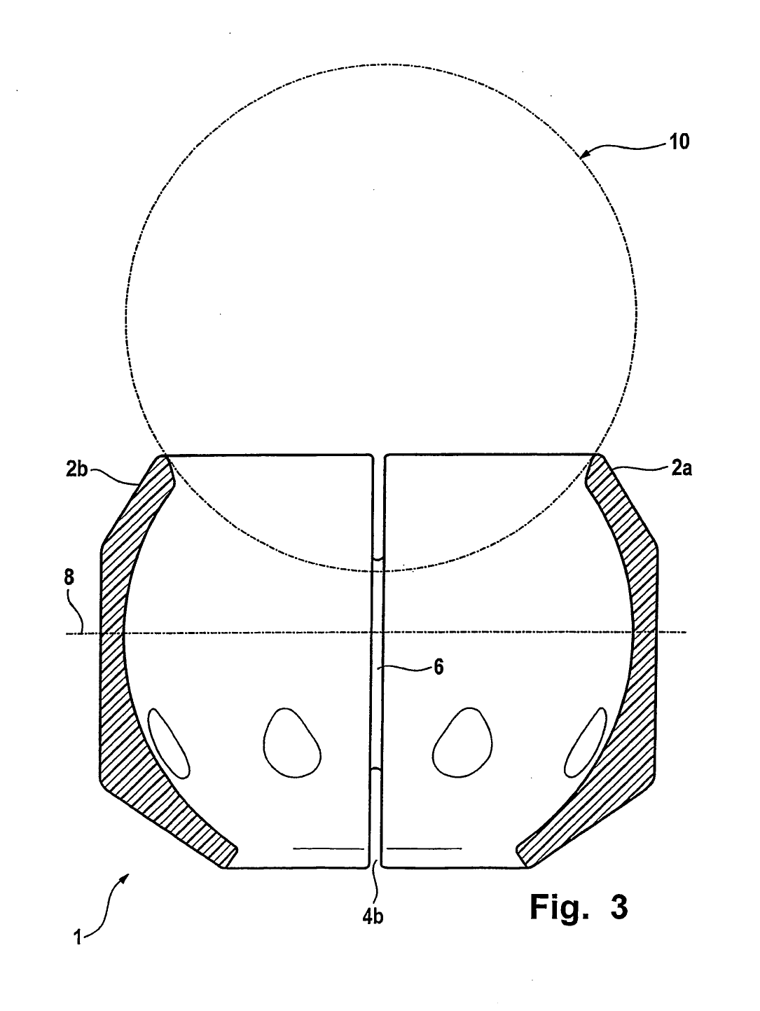

FIG. 3 illustrates a ball 10 of this type before it is introduced into the ball socket 1 during assembly. The ball socket 1, and, e.g., the elastically deformable region 6, are in a load-free state in FIG. 3.

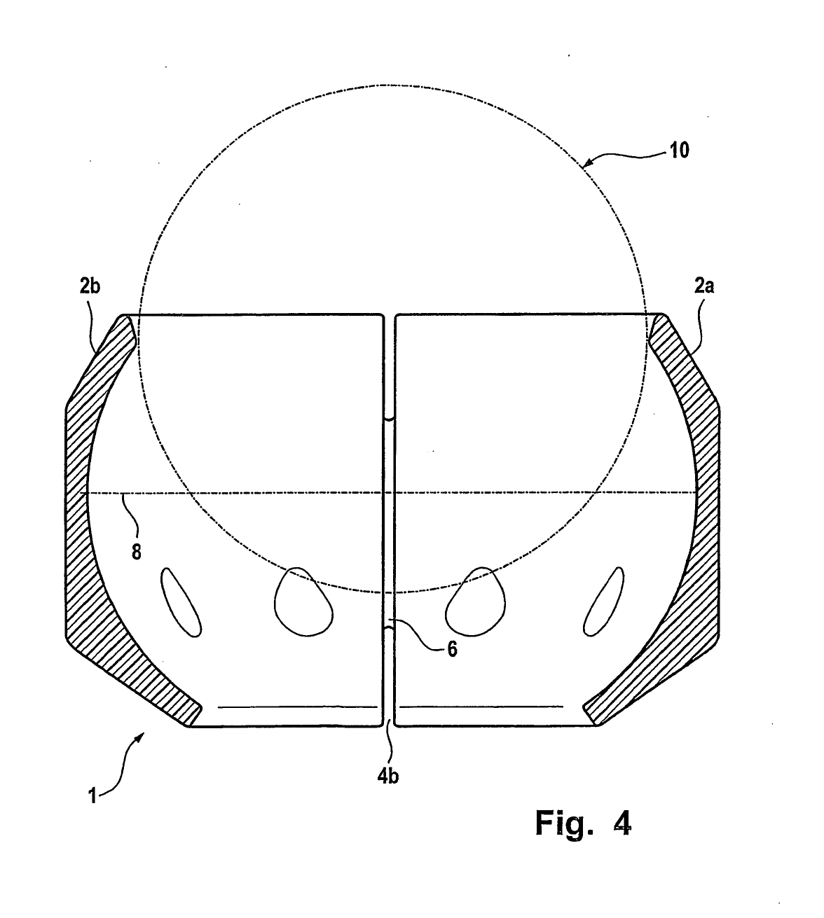

As illustrated in FIG. 4, the ball 10 has been forced by pressure sufficient to overcome a mechanical resistance of the elastically deformable region 6 to penetrate partway into the receiving regions, delimited by the part-sockets 2a (right-hand side) and 2b (left-hand side), of the ball socket 1. This stretches the elastically deformable region 6 arranged along the gap 4b. This may be recognized in that the distance between the two part-sockets 2a, 2b as illustrated in FIG. 4 is greater than the distance illustrated in FIG. 3. Due to the elastically deformable region which connects the two part-sockets 2a, 2b to one another, these two part-sockets 2a, 2b may be moved relative to one another when the ball 10 is being inserted into the ball socket 1.

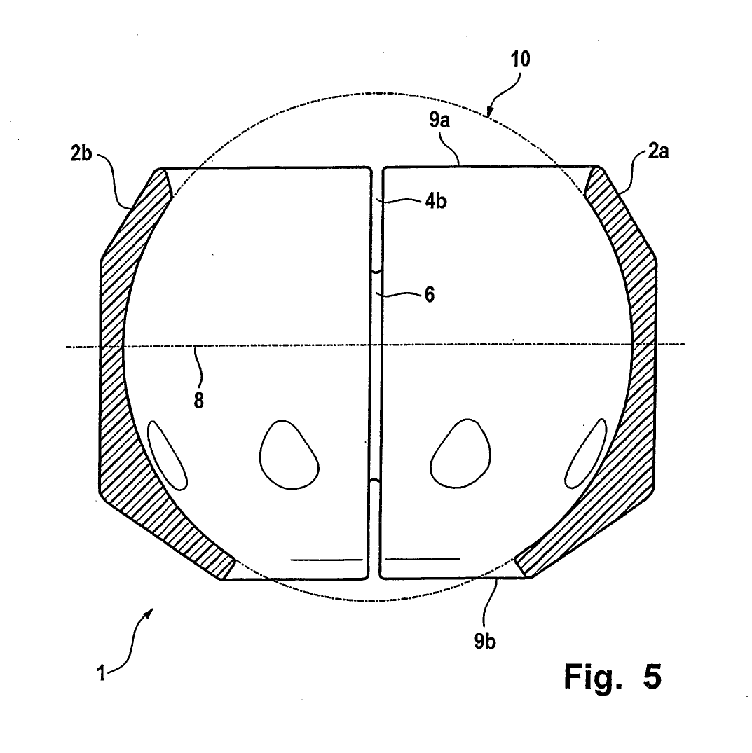

FIG. 5 illustrates how the ball 10 has been completely received in the ball socket 1. The ball socket 10 is covered within the region covered by the two part-sockets 2a, 2b. Since the elastically deformable region, after insertion of the ball 10 into the ball socket is complete, springs back into its original shape, the ball 10 is securely received in the ball socket 1.

The ball socket 1 covers or receives the ball 10 in the region of what is referred to as a ball layer. This ball layer is delimited at the top by a circle 9a indicated by a circle line and at the bottom by a circle 9b indicated by a circle line. These two circles 9a, 9b are arranged parallel to the equator 8 indicated by the equator line.

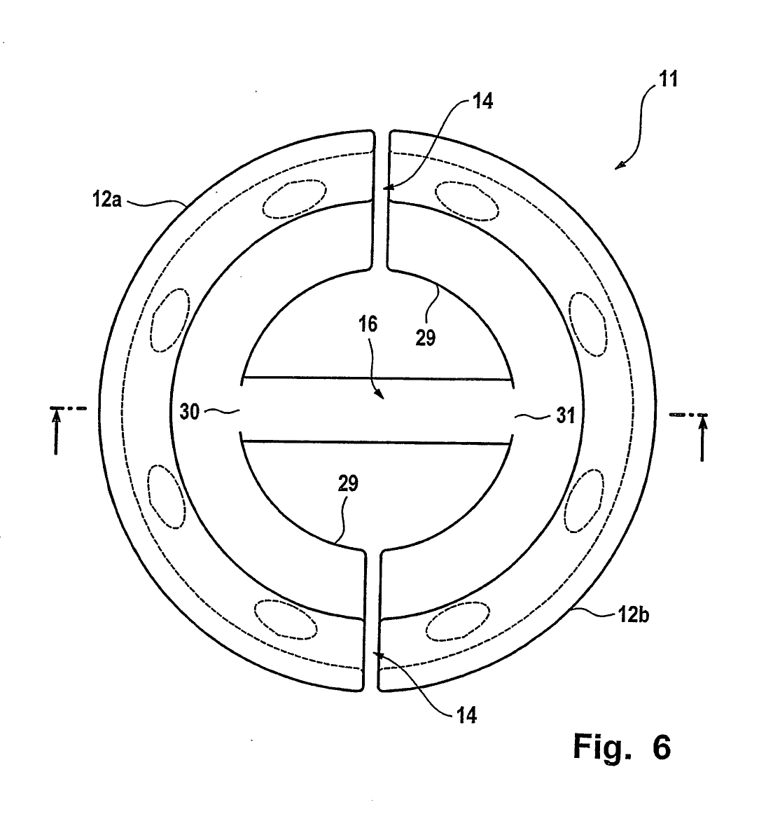

FIGS. 6 to 9 illustrate a ball socket 11 in a further configuration. This ball socket 11 is formed by two part-sockets 12a, 12b, which are connected to one another by an elastically deformable region 16. The two part-sockets 12a, 12b are separated by two gaps 14, which are arranged or oriented perpendicular to the elastically deformable region 16. The elastically deformable region is arranged between two portions 30, 31 of a circle 29 which is interrupted by the gaps 14 and delimits the two part-sockets 12a, 12b.

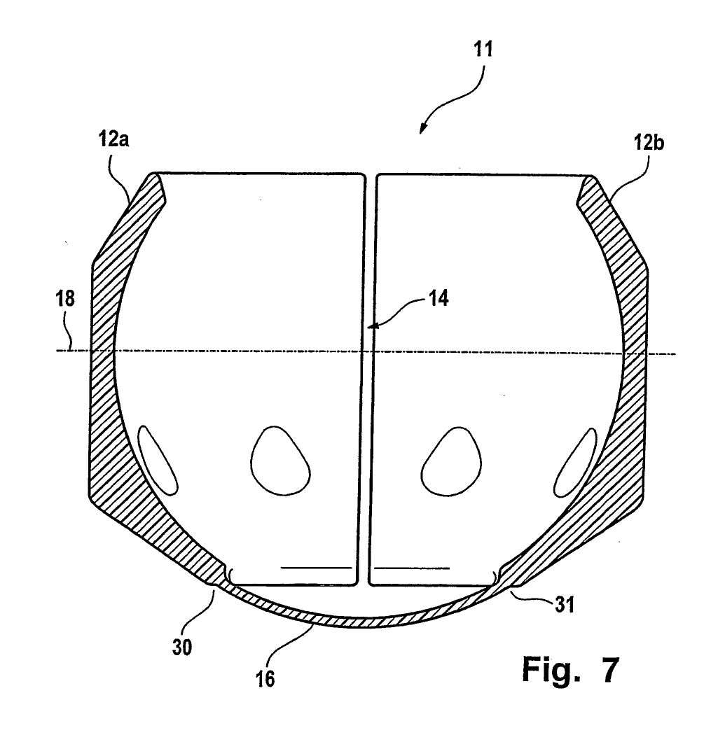

FIG. 7 illustrates the ball socket 11 in accordance with the sectional view indicated by the two arrows illustrated in FIG. 6. This illustration clearly reveals the single-piece arrangement of the ball socket 11, i.e., the unit made up of the left-hand part-socket 12a, the elastically deformable region 16 and the right-hand part-socket 12b. FIG. 7 also illustrates the gap 14. As in the exemplary embodiment of the ball socket 1 illustrated in FIGS. 1 to 5, the part-sockets 12a, 12b and therefore the entire ball socket 11 extend from a region above an equator 18 indicated by an equator line to a region below the equator 18 indicated by the equator line. Consequently, the ball 11 received by the ball socket 11 may be securely held in place.

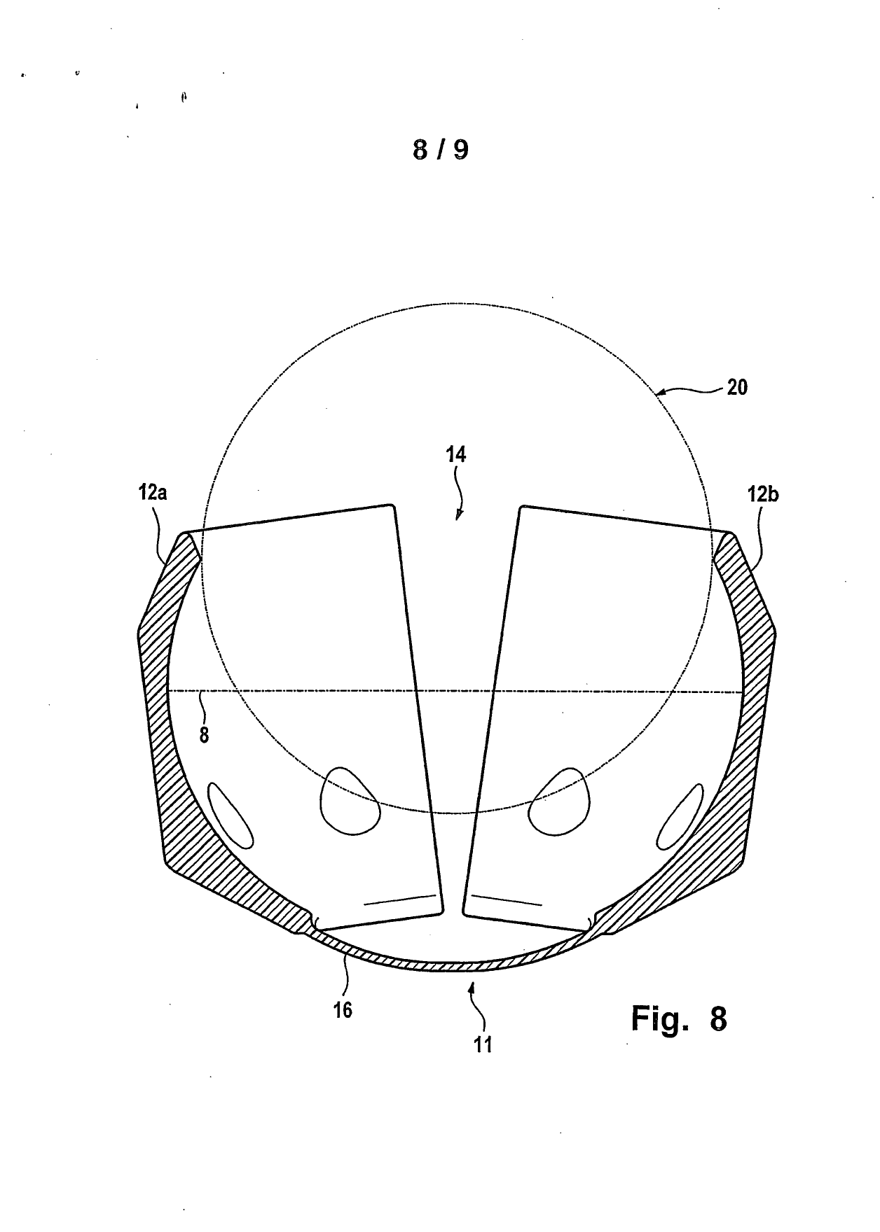

FIG. 8 illustrates, in a corresponding manner to FIG. 4, how a ball 20 is inserted into the ball socket 11. On account of a force with which the ball 20 is pressed downwardly, the two part-sockets 12a, 12b are folded open in scissor or clamp fashion, with the elastically deformable region 16 stretching. A relative movement of the part-socket 12a with respect to the part-socket 12b of this type when the ball 20 is being received is made possible by the nature of the elastically deformable region 16. As a result, the gap 14 is widened from the bottom upward.

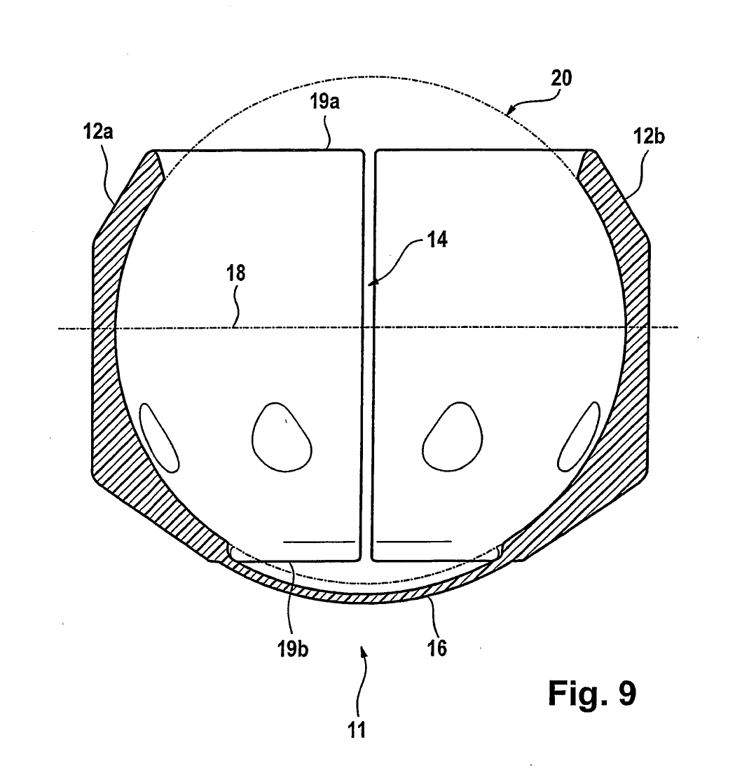

FIG. 9 illustrates the ball 20 which has been received in a ball socket 11. After the ball 20 has been inserted, the elastically deformable region 16 snaps or springs back into a starting position. This restores the original distance between the two part-shells 12a, 12b. The gap 14 also reverts to its original width and the ball 20 is covered over a ball layer by the ball socket 11. This ball layer is delimited at the top by a circle 19a indicated by a circle line and at the bottom by a circle 19b indicated by a circle line, both of which are arranged parallel to the equator 18.

The ball sockets 1, 11 may have a greater wall thickness than conventional ball sockets and permit the ball 10, 20 to be engaged around to a greater extent. This may result in a wider range of applications with hard and brittle plastics. Furthermore, the wear resistance under very high loads may be increased. Axial and radial prestressing conditions may be significantly improved compared to the conventional devices (such as those described, e.g., in German Published Patent Application No. 42 11 897), so that, for example, there may be no need to provide any protection against twisting. The devices hereof may provide an in relative terms thicker, more wear-resistant ball socket 1, 11 to be provided under the same installation conditions.

The design and assembly problems which may occur with conventional devices may be eliminated in accordance with the ball socket 1 by the elastically deformable region 6 arranged along the gap 4b. Contrary to other design solutions, only tensile forces may occur along the elastically deformable region, which may be designed, for example, as a thin-walled gap 4b. A ball geometry which is provided by the region covered by the ball socket 1 may not be affected by forced deformation.

With respect to ball socket 11, design and assembly problems which occur may be eliminated by the elastically deformable region 16 which is arranged in a lower region of the ball socket 11. The elastically deformable region 16 of the ball socket 11 may, for example, be arranged in the form of a web and surround a pole of the ball 20 below the equator 18. It may be provided that the thin-walled, elastically deformable region 16 of web-like arrangement is easily deformable compared to the remainder of the ball socket, e.g., the two part-sockets 12a, 12b.

1-13. (canceled)

14. A ball socket for receiving a ball, comprising:
at least one elastically deformable region.

15. The ball socket according to claim 14, wherein the elastically deformable region is formed of an elastically deformable material.

16. The ball socket according to claim 14, wherein the elastically deformable region includes an elastically deformable geometry.

17. The ball socket according to claim 14, wherein the ball socket is adapted to cover a ball portion of the ball, the ball portion delimited by at least one circle.

18. The ball socket according to claim 14, wherein the ball socket is adapted to cover a ball portion of the ball, the ball portion delimited by two circles arranged parallel to one another, the ball socket arranged as a ball layer

19. The ball socket according to claim 14, wherein the ball socket includes at least one gap.

20. The ball socket according to claim 19, wherein the gap is oriented perpendicular to at least one circle that delimits a ball portion of the ball that is covered by the ball socket.

21. The ball socket according to claim 19, wherein the elastically deformable region is arranged as an elongate portion arranged diagonally with respect to the gap.

22. The ball socket according to claim 19, wherein the at least one gap includes two gaps arranged diagonally with respect to one another along a circumference of the ball.

23. The ball socket according to claim 22, wherein the elastically deformable region is arranged in one of the two gaps.

24. The ball socket according to claim 17, wherein the elastically deformable region is arranged between a first portion of the circle and a second portion of the circle.

25. The ball socket according to claim 18, wherein the elastically deformable region is arranged between a first portion of the circles and a second portion of the circles.

26. The ball socket according to claim 14, wherein the elastically deformable region includes a thin-walled region.

27. A system, comprising:
a rotatably mounted connection arrangement adapted to connect a first part to a second part in a vehicle, the first part including ball as a connection element, the second part including a ball socket as a connection element and adapted to receive the ball, the second part including at least one elastically deformable region.
